(19) United States
(12) Patent Application Publication
(10) Pub. No.: US 2024/0425683 A1
(43) Pub. Date: Dec. 26, 2024

(54) DEGRADABLE POLYMERIC COMPOSITIONS AND ARTICLES COMPRISING SAME

(71) Applicant: TECHNION RESEARCH & DEVELOPMENT FOUNDATION LIMITED, Haifa (IL)

(72) Inventors: Maya DAVIDOVICH-PINHAS, Haifa (IL); Jasmine ROSEN KLIGVASSER, Haifa (IL)

(21) Appl. No.: 18/698,539

(22) PCT Filed: Oct. 3, 2022
(86) PCT No.: PCT/IL2022/051051

§ 371 Date: Apr. 4, 2024

Related U.S. Application Data
(60) Provisional application No. 63/251,755, filed on Oct. 4, 2021.

(51) Int. Cl. C08L 1/28; C08J 5/18; C08K 5/053; C08K 5/103; C08K 5/11

(52) U.S. Cl. CPC C08L 1/28; C08J 5/18; C08K 5/053; C08K 5/103; C08K 5/11; C08J 2301/28; C08L 2201/06; C08L 2203/16; C08L 2205/06

(57) ABSTRACT

The present invention provides a composition comprising (i) a cellulose-based polymer, and (ii) a plasticizer; wherein a weight per weight (w/w) concentration of the plasticizer within the composition is from 0.1 to 20%; and wherein a glass transition temperature (Tg) of the composition is reduced by at least 20% compared to a Tg of the cellulose-based polymer. Furthermore, provided herein are articles comprising the composition of the invention, and methods for manufacturing thereof.

### CROSS REFERENCE TO RELATED APPLICATIONS

This application claims the benefit of priority to U.S. Provisional Patent Application No. 63/251,755 filed Oct. 4, 2021, entitled “DEGRADABLE POLYMERIC COMPOSITIONS AND ARTICLES COMPRISING SAME” the contents of which are incorporated herein by reference in their entirety.

### FIELD OF THE INVENTION

The invention relates to the field of degradable polymeric materials and to use thereof in the preparation of the biodegradable articles.

### BACKGROUND OF THE INVENTION

A major source of preoccupation in modern society has been the amount of waste produced and its impact in the environment, increasing pollution and using valuable spaces as landfill. Thus, there has been great interest in the manufacture of biodegradable disposable articles, and especially when these are made from recycled or discarded material.

To overcome those ecological problems and minimize the amount of produced plastic products, progress has been made in two fronts: recovering and recycling current plastic products and developing new sustainable materials to replace the petroleum-based plastic. Currently, “mechanical recycling” is the most common recycling process. In “mechanical recycling” used plastic products are grounded up and melted together with novel materials. The new mixture gets remolded into a new product. However, this method does not provide a solution for the composite material, such as laminate packages and paper cups. An alternative solution for reducing plastic waste is developing more environmentally friendly materials such as biopolymers. These materials mimic the physical characterizations of plastic materials and have substantially less environmental impact than conventional plastics.

Natural biopolymer plastics exhibit biodegradation properties and low carbon footprint, which are highly significant from environmental point of view. However, natural biopolymers demonstrate inferior physicochemical properties essential for their functionality in the plastic industry. Due to their hydrophilic nature they exhibit water permeability over time. This property is very important mostly in the agriculture and food industries, where water content can significantly deteriorate the product safety and shelf life. Additional drawback of natural biopolymers relates to their poor thermal stability and mechanical properties which is directly related to their natural origin and their structure. Moreover, processing conditions of biopolymers are usually limited to solution casting or coating methods that include the use of organic solvents, thus limiting their applications in the plastic industry.

Therefore, it is highly advantageous to develop a biopolymeric composition suitable for hot-melt extrusion, and applicable for manufacturing of biodegradable plastics using conventional molding methods.

### SUMMARY OF THE INVENTION

In one aspect, there is a composition comprising (i) a cellulose-based polymer, and (ii) a plasticizer; wherein a weight per weight (w/w) concentration of the plasticizer within the composition is from 0.1 to 20%; and wherein a glass transition temperature (Tg) of the composition is reduced by at least 20% compared to a Tg of the cellulose-based polymer.

In one embodiment, the composition is substantially biodegradable.

In one embodiment, the cellulose-based polymer comprises at least one of: alkyl cellulose, nitrocellulose, carboxylated cellulose or any combination thereof.

In one embodiment, the alkyl cellulose comprises ethylcellulose, methylcellulose, propylcellulose, hydroxypropyl cellulose, hydroxyethyl cellulose or any combination thereof.

In one embodiment, a weight per weight (w/w) concentration of the cellulose-based polymer within the composition is from 60 to 99%.

In one embodiment, the plasticizer reduces (i) Tg of the cellulose-based polymer by at least 20%; (ii) viscosity of the cellulose-based polymer in a molten state by at least 10%.

In one embodiment, the plasticizer comprises a food acceptable material.

In one embodiment, the plasticizer is selected from the group consisting of: a phospholipid, a fatty acid, a monoglyceride, a diglyceride a triglyceride, alkylated citrate, a monosaccharide, a disaccharide, an oligosaccharide or any combination thereof.

In one embodiment, the composition is characterized by a melting temperature (Tm) between 6° and 300° C.

In one embodiment, the composition is characterized by elongation at break of at least 4%.

In one embodiment, the composition is characterized by a glass transition temperature (Tg) of less than 130° C.

In one embodiment, the composition further comprising between 0.1 and 10% additive by weight of the composition.

In one embodiment, the composition is extrudable.

In another aspect, there is an article comprising the composition of the invention.

In one embodiment, the article is stable at a temperature below the Tg.

In one embodiment, the article is substantially water vapor impermeable.

In one embodiment, the article is substantially biodegradable.

In one embodiment, the article is in a form of a packaging material or a non-woven fabric.

In another aspect, there is a method for manufacturing the article of the invention comprising:
(i) providing the composition of the invention;
(ii) exposing the composition to conditions suitable for molding, thereby obtaining a moldable composition;
(iii) modeling the moldable composition, thereby forming the article.

In one embodiment, the conditions suitable for molding comprise thermal exposure to a temperature above the Tg of the composition.

In one embodiment, modeling comprises providing a predetermined shape to the moldable composition.

In one embodiment, modeling is by a process selected from the group consisting of: extrusion, molding, spinning, compression, injection, non-woven, blowing and thermoforming or any combination thereof.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

In addition to the exemplary aspects and embodiments described above, further aspects and embodiments will become apparent by reference to the study of the following detailed description.

### BRIEF DESCRIPTION OF THE FIGURES

FIGS. 1A-C represent micrographs of ˜300 μm thick films prepared using ethylcellulose (EC) (1A), EC+5 wt % triethyl citrate (TEC) (EC5T) (1B), and EC+5 wt % Myvacet (EC5M) (1C) placed on the Technion logo printed on a white paper.

FIG. 2 is a graph representing typical stress-strain diagrams obtained during mechanical testing for EC films containing different plasticizers (T—TEC and M—Myvacet) at different concentrations (5 and 10% wt.).

FIG. 3 is a bar graph representing extension at break as obtained for EC films containing different plasticizers TEC (T) and Myvacet (M) at different concentrations (5 and 10% wt.) using TA1 with 500N load cell and 10 mmmin⁻¹ extension speed. PE represents a polyethylene film as a control.

FIGS. 4A-B are graphs representing exemplary heat flow curves received for EC (solid black line), EC5T (solid grey line), and EC5M (dashed grey line) during cooling (4A) and heating (4B), (T—TEC and M—Myvacet), at different concentrations (5 and 10% wt.).

FIGS. 5A-D are graphs or bar graphs representing Dynamic Mechanical Analysis (DMA) of EC films containing different plasticizers (T—TEC and M—Myvacet) at different concentrations (5 and 10% wt.). (5A) represents Loss modulus, (5B) represents storage moduli, (5C) represents tan δ curves, and (5D) represents calculated T_{g} values received from the DMA analysis.

FIGS. 6A-F are high resolution SEM images received for (6 A-B) EC, (6 C-D) EC5T, and (6E-F) EC5M films at X40 (6A, 6C, 6E) and X10 (6B, 6D, 6F) magnification.

FIGS. 7A-C are graphs showing second heating DSC thermograms of EC 45 cP (7A), EC 20 cP (7B) and EC 10 cP (7C) with different plasticizers and without plasticizers (control) at 5° Cmin⁻¹ heating rate.

FIGS. 8A-B are bar graphs showing glass transition (Tg) of different EC grades with different plasticizers, and Tg of different EC grades without plasticizers (control) (FIG. 8A); and melting (Tm) temperatures of different EC grades with different plasticizers, and Tg of different EC grades without plasticizers (control) (FIG. 8B).

### DETAILED DESCRIPTION OF THE INVENTION

The present invention is related, in part, to a composition comprising a cellulose-based polymer and a plasticizer. In one embodiment, the composition of the invention is characterized by sufficient elasticity and by a low glass transition temperature (Tg). In one embodiment, the composition is suitable for manufacturing of at least partially biodegradable articles by a method selected from the group consisting of: melt-extrusion, injection molding, spinning, melt-blowing and thermoforming or any combination thereof. The compositions, described herein, have been optimized for use in manufacturing of eco-friendly articles appropriate for food storage and processing.

### Composition

In one aspect of the invention, there is a composition comprising (i) a cellulose-based polymer, and (ii) a plasticizer; wherein a weight per weight (w/w) concentration of the plasticizer within the composition is from 0.1 to 20%, and wherein a glass transition temperature (Tg) of the composition is reduced by at least 20%, compared to a Tg of the cellulose-based polymer.

In some embodiments, a Tg of the composition is reduced by at least 10%, compared to a Tg of the cellulose-based polymer.

In some embodiments, the composition is substantially devoid of a solvent. In some embodiments, the composition comprises a trace amount of a solvent (e.g. less than 5%, less than 3%, less than 2%, less than 1%, less than 0.5%, less than 0.1% w/w).

In some embodiments, any one of the cellulose-based polymer and the plasticizer encompasses a single species, or a plurality (e.g. 2, 3, 4, 5, or more) of chemically distinct species.

In some embodiments, the composition (e.g. shapeable or moldable composition) is substantially devoid of an additional polymer (which is not the cellulose-based polymer and the plasticizer). In some embodiments, the composition is substantially devoid of a non-biodegradable and/or non-biocompatible polymer. In some embodiments, the composition consists essentially of the cellulose-based polymer and the plasticizer, as described herein. In some embodiments, the composition comprises less than 5%, less than 3%, less than 2%, less than 1%, less than 0.5%, less than 0.1% w/w of an additional polymer. In some embodiments, the additional polymer is devoid of a cellulose-based polymer.

In some embodiments, the term “biodegradable” describes a composition or article which can decompose under environmental condition(s) into breakdown products. Such environmental conditions include, for example, exposure to open field cultivation conditions such as soil microbiome, rhizosphere, temperature of between 0 and 50° C., UV radiation, irrigation, hydrolysis (decomposition via hydrolytic cleavage), enzymatic catalysis (enzymatic degradation), and mechanical interactions. This term typically refers to composition/article, which is capable of decomposition under these conditions, such that at least 50 weight percent of the composition/article decomposes within a time period shorter than two years.

In some embodiments, the term “biodegradable” as used in the context of embodiments of the invention, also encompasses the term “bioerodible”, which describes a composition/article which decomposes under environmental conditions into smaller fractions, thus substantially losing its structure and/or mechanical properties. In some embodiments, the term “bioerosion” refers to erosion of the composition/article initiated by microorganisms, and resulting in at least partial degradation of the composition/article.

In some embodiments, the composition is a composite material. In some embodiments, the composition is a solid bulk material. In some embodiments, the composition is a powderous composition. In some embodiments, the composition is characterized by a particle size between 1 um and 10 cm, between 1 um and 1 mm, between 1 um and 1 cm, between 1 mm and 10 cm, including any range between. In some embodiments, the composition is a solid material. In some embodiments, the entire composition is a solid matrix, comprising the plasticizer homogenously distributed the within. In some embodiments, the cellulose-based polymer forms a matrix composed of intertwined polymeric chains. In some embodiments, the cellulose-based polymer is randomly (e.g. non-aligned) distributed within the matrix or within the composite.

In some embodiments, the composition comprises a cellulose-based polymer at a w/w concentration ranging from 60 to 99%, from 60 to 65%, from 65 to 70%, from 70 to 75%, from 75 to 80%, from 80 to 85%, from 85 to 87%, from 87 to 90%, from 90 to 92%, from 92 to 95%, from 95 to 97%, from 97 to 98%, from 98 to 99%, including any range or value therebetween.

In some embodiments, the cellulose-based polymer comprises a chemically modified cellulose. In some embodiments, the cellulose-based polymer comprises an alkylated (e.g. C1-C10 alkyl) cellulose. In some embodiments, the cellulose-based polymer is selected from the group consisting of: alkyl cellulose, nitrocellulose, carboxylated cellulose or any combination thereof.

Non-limiting examples of alkyl cellulose or alkylated cellulose include but are not limited to: ethylcellulose, methylcellulose, propylcellulose, hydroxypropyl cellulose, hydroxyethyl cellulose or any combination thereof.

In some embodiments, the cellulose-based polymer substantially comprises ethylcellulose. In some embodiments, the ethycellulose (EC) comprises a plurality of ECs having different molecular weights. In some embodiments, EC comprises one or more of EC 10 cP, EC 20 cP, EC 45 cP or any combination thereof.

In some embodiments, the cellulose-based polymer is characterized by a modification degree (e.g. alkylation degree) between about 5 and 60%, between about 10 and 60%, between about 5 and 50%, between about 10 and 50%, between about 10 and 40%, between about 5 and 45%, between about 10 and 45%, between about 20 and 60%, between about 20 and 50%, including any range between. In some embodiments, the modification degree refers to the weight portion of the chemical modification (e.g. alkyl group) relative to the total weight of the cellulose-based polymer.

In some embodiments, the cellulose-based polymer is characterized by a viscosity between about 5 and about 300 cP, between about 5 and about 200 cP, between about 5 and about 100 cP, between about 10 and about 100 cP, between about 5 and about 80 cP, between about 5 and about 70 cP, between about 5 and about 60 cP, between about 5 and about 50 cP, between about 5 and about 45 cP, between about 10 and about 100 cP, between about 10 and about 70 cP, between about 10 and about 60 cP, between about 5 and about 50 cP, including any range between, wherein viscosity refers to the viscosity of the cellulose-based polymer solution (e.g. 5% w/w of the cellulose-based polymer in a toluene/ethanol 80:20 solution), optionally when measured at a room temperature, such as between 20 and 25° C.

In some embodiments, the cellulose-based polymer has a cellulose content of at least 40%, at least 50%, at least 60%, at least 70%, at least 75%, at least 80%, at least 85%, at least 90%, at least 92%, at least 95%, at least 97%, at least 99%, including any range between.

In some embodiments, the cellulose content, as used herein, is related to cellulose, and hemicellulose or any combination thereof. As used herein, the terms “cellulose” and “hemicellulose” are related to a non-modified (or non-derivatized) polysaccharide.

In some embodiments, the composition comprises a plasticizer at a w/w ratio between 0.1 and 20%, between 0.1 and 1%, between 1 and 1.5%, between 1.5 and 2%, between 2 and 2.5%, between 2.5 and 3%, between 3 and 3.5%, between 3.5 and 4%, between 4 and 4.5%, between 4.5 and 5%, between 5 and 5.5%, between 5.5 and 6%, between 6 and 6.5%, between 6.5 and 7%, between 7 and 8%, between 8 and 9%, between 9 and 10%, between 10 and 11%, between 11 and 12%, between 12 and 13%, between 13 and 15%, between 15 and 17%, between 17 and 20%, including any range therebetween.

In some embodiments, the plasticizer is a small molecule. In some embodiments, the plasticizer is a polymer. In some embodiments, the plasticizer is compatible with the cellulose-based polymer. In some embodiments, the plasticizer is miscible with the molten cellulose-based polymer. In some embodiments, the plasticizer is a small organic molecule having a MW of less than 1,000 Daltons (Da). In some embodiments, the plasticizer has a MW of between 100 and 1,000 Da, between 100 and 300 Da, between 100 and 200 Da, between 200 and 500 Da, between 200 and 1000 Da, between 200 and 300 Da, between 100 and 500 Da, between 100 and 800 Da, between 300 and 500 Da, between 100 and 1,000 Da, between 500 and 800 Da, between 500 and 1,000 Da, between 800 and 1,000 Da, including any range between. Each possibility represents a separate embodiment. As used herein, the term “MW” refers to an average molecular weight of the plasticizer (e.g. weight average molecular weight, when referred to polymeric or oligomeric plasticizers).

In some embodiments, the plasticizer is a polymer characterized by MW between about 1000 and 50.000 Da, between about 2000 and 100.000 Da, between about 2000 and 50.000 Da, between about 2000 and 30.000 Da, including any range between.

In some embodiments, the plasticizer is a polymer selected from a synthetic polymer, a natural polymer (e.g. isolated natural polymer), an organic polymer, and an inorganic polymer, including any mixture or a copolymer thereof. In some embodiments, the plasticizer is or comprises a food-grade polymer. In some embodiments, the inorganic polymer is or comprises a clay mineral (e.g. in a form of a nano-particulate matter). In some embodiments, the plasticizer is or comprises a clay mineral (e.g. in a form of nanoparticles, fibers such as micro-fiber, nano-fibers, etc., and/or in a form of hollow tubes such as single-wall or multi wall nano-tubes). In some embodiments, the clay mineral is or comprises a silicate polymer, an aluminosilicate polymer or both. In some embodiments, the inorganic polymer is or comprises halloysite. In some embodiments, the inorganic polymer is or comprises halloysite nanotube.

In some embodiments, any one of the synthetic polymer, the natural polymer and/or an organic polymer is a thermoplastic polymer. In some embodiments, any one of the synthetic polymer, the natural polymer and/or an organic polymer is substantially devoid of a cross-linking. In some embodiments, the plasticizer is a non-crosslinked polymer. In some embodiments, the plasticizer (e.g. a polymer and/or a small molecule) is a biocompatible and/or a biodegradable compound.

In some embodiments, any one of the synthetic polymer and the organic polymer is selected from a polyolefin (e.g. a polyethylene, polypropylene), a polyalkoxylate, a polyethylene glycol (PEG), polyester, polystyrene, C1-C8 alkyl styrene, polyvinyl chloride, polycarbonate, a polyamide (e.g. Nylon, etc.), polyurethane, an aromatic polyether ketone resin, a polyphenylene sulfide, acrylonitrile butadiene styrene (ABS); styrene acrylonitrile copolymers (SAN); a polyol (e.g. a polyvinyl alcohol), poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; unsaturated polyesters; poly(alkane terephthalates), such as poly(ethylene terephthalate) (PET); poly(alkane naphthalates), such as poly(ethylene naphthalate) (PEN); ionomers; vinyl acetate/polyethylene copolymers; cellulose acetate; cellulose acetate butyrate; fluoropolymers; poly(styrene)-poly(ethylene)copolymers; poly(carbonate)/aliphatic PET blends and PET and PEN copolymers, including polyolefinic PET and PEN, including any copolymer and any mixture thereof.

In some embodiments, the biodegradable polymer is or comprises any one of: a polyester, a polyamide, Polyglycolic acid, Polyorthoester, Polyphosphoester, Polyanhydride, Polyester-amide, Polyaminoacid (e.g. random polyaminoacid), polyimine, Poly(L-lactic acid), Poly(caprolactone), Poly (lactic-coglycolic acid), Poly (3-hydroxybutyric acid), Poly (sebacic acid), Poly (adipic acid), Polyposphazene, Poly (dioxanone), Poly-p-hydroxybutyrate-co-p-hydroxy valerate (PHBV), and PBAT, including any copolymer and any mixture thereof.

In some embodiments, the natural polymer comprises a polymer derived from a natural product. In some embodiments, the natural polymer is in a form of a fiber (nano-fiber, and/or micro-fiber) or a nano-particle (e.g. a nanotube, a nanoparticle characterized by a cross-section between 1 and 100 nm). In some embodiments, the natural polymer comprises starch, starch fibers (e.g. nano-fiber, or micro-fibers), a polypeptide (e.g. a peptide, a protein, such as gelatin, zein, or both), silk, keratin, a polysaccharide (e.g. alginic acid, hyaluronic acid, chitosan, a gum, etc.), and collagen, or any mixture or copolymer thereof.

In some embodiments, the plasticizer has a MW less than 1,000 Da, less than 900 Da, less than 800 Da, less than 700 Da, less than 600 Da, less than 500 Da, less than 400 Da, less than 300 Da, less than 200 Da, including any range between. Each possibility represents a separate embodiment. In some embodiments, the plasticizer has a MW more than 100 Da, more than 200 Da, more than 300 Da, more than 400 Da, more than 500 Da, more than 600 Da, more than 700 Da, more than 800 Da, or more than 900 Da. Each possibility represents a separate embodiment.

In some embodiments, the plasticizer comprises a food acceptable material. In some embodiments, the plasticizer is selected from the group consisting of: a phospholipid, a fatty acid, a fatty alcohol, a polyol, a lipid, a fatty acid monoglyceride, a fatty acid diglyceride, a fatty acid triglyceride, alkylated citrate, a monosaccharide, a disaccharide, an oligosaccharide or any combination thereof.

In some embodiments, the plasticizer is selected from triethyl citrate (TEC), Myvacet (Myv, an acetoglyceride-based emulsifier), glycerol, sorbitan mono-oleate or monostearate (SMO, SMS), glyceryl mono-oleate (GMO), and glyceryl mono-stearate (GMS) or any combination thereof. In some embodiments, the plasticizer is a surface active agents (e.g. an emulsifier). In some embodiments, the plasticizer is an emulsifier miscible with the cellulose-based polymer (e.g., wherein the cellulose-based polymer is in a molten state). Various surfactants or surface active agents miscible with the alkylated cellulose (e.g., methyl-, or ethyl-cellulose) are known in the art. The term “surfactant” is well understood by a skilled artisan, as being related inter alia to an amphiphilic agent reducing the surface tension of two immiscible liquids.

In some embodiments, the plasticizer is selected from the group consisting of: propylene glycol (PG), glycerin, ethylene glycol, or any combination thereof.

In some embodiments, the plasticizer is any of TEC, Myvacet, GMO, SMO, and/or SMS. In some embodiments, the composition comprises ethylcellulose and between 5 and 10% w/w of the plasticizer. In some embodiments, the composition comprises ethylcellulose and between 5 and 10% w/w of the plasticizer selected from TEC, Myvacet, GMO, SMO, and/or SMS.

In some embodiments, the plasticizer is water immiscible. In some embodiments, the plasticizer is characterized by water solubility of less than 80 g/l, less than 70 g/l, less than 60 g/l, less than 20 g/l, less than 10 g/l, less than 1 g/l, less than 0.5 g/l, less than 0.1 g/l, less than 0.01 g/l, including any range therebetween. In some embodiments, the plasticizer is characterized by water solubility between 0.001 and 70 g/l, between 0.001 and 0.01 g/l, between 0.01 and 0.1 g/l, between 0.1 and 1 g/l, between 1 and 10 g/l, between 10 and 70 g/l, including any range therebetween.

In some embodiments, the plasticizer is devoid of a polyol (e.g. glycerol).

In some embodiments, the w/w ratio of the cellulose-based polymer to the plasticizer within the composition ranges between 5:1 to 20:1, between 5:1 to 6:1, between 6:1 to 7:1, between 7:1 to 8:1, between 8:1 to 10:1, between 10:1 to 12:1, between 12:1 to 13:1, between 13:1 to 14:1, between 14:1 to 15:1, between 15:1 to 17:1, between 17:1 to 20:1, between 20:1 to 22:1, between 22:1 to 25:1, between 25:1 to 30:1, including any range therebetween.

In some embodiments, the composition (e.g. the extrudate) is substantially homogenous. In some embodiments, the plasticizer and the cellulose-based polymer are mixed homogenously within the composition. In some embodiments, the plasticizer is compatible and/or miscible with the cellulose-based polymer, so as to result in a substantially homogenous composition (e.g. extrudate). In some embodiments, the extrudate comprising the cellulose-based polymer and the plasticizer of the invention, at an amount disclosed herein, is substantially devoid of phase separation (and optionally of additional mechanical or structural defects), and the extrudate is shapeable or formable, as described herein.

In some embodiments, the plasticizer reduces a glass transition temperature (Tg) of the cellulose-based polymer by at least 10%, by at least 20%, by at least 25%, by at least 30%, by at least 35%, by at least 40%, by at least 45%, by at least 50%, by at least 55%, by at least 60%, including any range between, compared to a Tg of the pristine cellulose-based polymer (i.e. substantially devoid of plasticizer).

In some embodiments, the plasticizer reduces Tg of the cellulose-based polymer by at most 70%, by at most 65%, by at most 60%, by at most 55%, by at most 50%, by at most 45%, by at most 40%, including any range between.

In some embodiments, the plasticizer reduces at least one of (i) Tg of the cellulose-based polymer by at least by at least 30%, by at least 35%, by at least 40%, by at least 45%, by at least 50%, by at least 55%, by at least 60%, including any range between; (ii) viscosity of the cellulose-based polymer in a molten state by at least 10%, by at least 10%, by at least 8%, by at least 6%, by at least 5%, by at least 4%, by at least 3%, including any range between.

Without being bound to any particular theory or mechanism, it is postulated that the plasticizer molecules reduce interactions between polymer chains and decrease crystallinity of the cellulose-based polymer, thus lowering viscosity and the Tg of the cellulose-based polymer.

In some embodiments, the plasticizer reduces a viscosity of the cellulose-based polymer and/or of the composition. In some embodiments, the plasticizer reduces a melt flow index (MFI) of the cellulose-based polymer. In some embodiments, the plasticizer reduces MFI of the cellulose-based polymer by at least 10%, at least 50%, at least 100%, at least 120%, at least 150%, including any range or value therebetween.

In some embodiments, the composition comprising the cellulose-based polymer and the plasticizer (e.g. at a concentration described herein) is characterized by a reduced MFI, compared to MH of the pristine cellulose-based polymer (being substantially devoid of a plasticizer). In some embodiments, the MH of the composition is reduced as described hereinbelow (Example 4). As used herein, the term MFI is referred to the amount of polymer extruded through a specific die over specific time. High MH value indicates on higher flowability (i.e. the ability of the composition to flow under pressure applied thereto) of the sample, which can be related to lower melt viscosity. In some embodiments, the plasticizer enhances flowability of the composition.

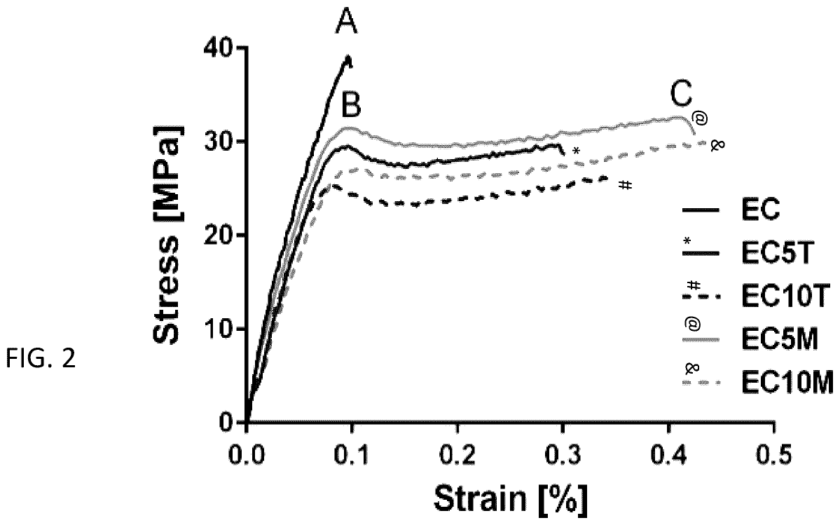

In some embodiments, the plasticizer enhances elasticity of the composition (as represented by FIG. 2, showing typical stress-strain curves of exemplary compositions disclosed herein). In some embodiments, the plasticizer reduces the elastic modulus of the composition by at least 10%, at least 12%, at least 14%, at least 15%, at least 17%, at least 20%, including any range between, compared to the elastic modulus of the pristine cellulose-based polymer.

The plasticizer provides a certain degree of flexibility, stretch ability or elasticity to the composition, which translates into shock-resistance properties to the articles or containing the composition of the invention.

In some embodiments, the composition is characterized by elastic modulus between 300 and 400 MPa.

In some embodiments, the plasticizer enhances elongation at break of the composition by at least 50%, at least 70%, at least 100%, at least 120%, at least 150%, at least 170%, at least 200%, at least 220%, at least 250%, at least 270%, at least 300%, at least 320%, at least 350%, including any range between, compared to elongation at break of the pristine cellulose-based polymer.

In some embodiments, the composition is characterized by elongation at break being between 4 and 10%, between 4 and 5%, between 5 and 6%, between 6 and 8%, between 8 and 9%, between 9 and 10%, between 10 and 15%, between 15 and 20%, including any range between.

In some embodiments, the composition is characterized by elasticity sufficient to retain its structural and/or functional properties during the manufacturing process, wherein the manufacturing process is as described hereinbelow. In some embodiments, the composition is characterized by elasticity sufficient for use in a melt-based modeling (e.g. melt extrusion, melt injection, thermoforming, etc.).

In some embodiments, the plasticizer increases or induces shapeability of the composition (e.g., viscoelastic properties). In some embodiments, the plasticizer increases or induces the biodegradability of the composition or of an article comprising same.

In some embodiments, the composition is characterized by a melting temperature (Tm) being between 60 and 80° C., between 80 and 100° C., between 100 and 120° C., between 150 and 170° C., between 170 and 200° C., between 200 and 250° C., between 250 and 300° C., including any range between.

In some embodiments, the composition is characterized by a Tg of less than 130° C., less than 120° C., less than 110° C., less than 100° C., less than 90° C., less than 85° C., less than 80° C., less than 75° C., less than 70° C., less than 65° C., less than 60° C., less than 55° C., less than 50° C., including any range between.

In some embodiments, the composition is a viscoelastic composition (as exemplified in the Examples section).

In some embodiments, the plasticizer modulates (increases or decreases) a surface contact angle of the cellulose based polymer.

In some embodiments, the composition further comprises an additive. In some embodiments, the ratio of the additive within the composition between 0.1 and 10%, between 0.01 and 0.05%, between 0.05 and 0.1%, between 0.1 and 0.5%, between 0.5 and 1%, between 1 and 2%, between 2 and 5%, between 5 and 10%, between 10 and 15%, between 15 and 20% by weight, including any range between.

In some embodiments, the additive is an antimicrobial agent, such as sorbic acid, propionic acid, citric acid, peracetic acid, etc.

In some embodiments, the additive is an anti-fogging agent, such as a monoglyceride or cellulose esters. Anti-fogging agents increase the surface energy of the plastic, thus reducing the water surface tension leading to a reduced contact angle and prevents from water molecules to condense on the surface.

In some embodiments, the additive is a UV absorber, such as conjugated fatty acids, conjugated polyunsaturated compounds (e.g. lycopene) and polyphenols. UV radiation can adversely affect substances packed inside plastic materials, such as food, pharmaceutical, household, and cosmetic products, leading to color fading, accelerated oxidation, and loss of nutritional value. Protecting light-sensitive materials against UV radiation using UV-absorber agents is, therefore, highly desirable in food and agriculture packaging.

In some embodiments, the composition further comprises an additive selected from a dye, a pigment, a scent, or any combination thereof.

In some embodiments, the composition is a solid at a temperature less than 200° C., less than 150° C., less than 100° C., less than 70° C., less than 50° C., less than 30° C., less than 20° C., less than 10° C. including any range therebetween.

In some embodiments, the composition is stable at a melting temperature, wherein stable as used herein refers to the ability of the composition to maintain its chemical integrity during the manufacturing process. In some embodiments, the composition is characterized by a mechanical strength sufficient for manufacturing of an article.

In some embodiments, the composition is substantially biodegradable. In some embodiments, the composition is a biodegradable composition. In some embodiments, the composition is moldable. In some embodiments, the composition is shapeable (i.e., deformable). In some embodiments, the composition is extrudable. In some embodiments, the composition is meltable. In some embodiments, the composition is shapeable in a molten state. In some embodiments, the composition in a molten state is moldable, so to enable providing the composition into a predetermined shape or form.

In some embodiments, a shapeable or moldable composition is referred to a viscoelastic composition. In some embodiments, a shapeable or moldable composition is deformable in a molten state. In some embodiments, a shapeable or moldable composition is deformable in a molten state, and substantially retains its shape (e.g. a three-dimensional shape) upon solidification of the composition. In some embodiments, a shapeable or moldable composition is deformable in a molten state, so as to obtain an article with a predetermined shape upon solidification of the composition. It should be understood that the term “shape” (e.g. a three-dimensional shape, or a two-dimensional shape) encompasses any geometrical shape including any irregular shape or structure.

### Article

In another aspect, there is an article comprising the composition of the invention.

In some embodiments, the article is in a form of a layer. In some embodiments, the article is in a form of a film. In some embodiments, the article is in a form of a packaging material or a non-woven fabrics.

In some embodiments, the article is a three-dimensional article. In some embodiments, the 3D article has any 3D geometrical shape including any irregular shape or structure. In some embodiments, the article is in a form of a container (e.g. dishware).

The invention is particularly useful for articles or containers used in agriculture and food storage, such as plant pots, plug trays, and any containers or receptacles of similar use. In some embodiments, the article is biocompatible. In some embodiments, the article is at least partially degradable or biodegradable.

In some embodiments, the article is stable at a temperature below the Tg of the composition. As used herein the term “stable” refers to the capability of the article to substantially maintain its structural and/or mechanical integrity. In some embodiments, the composition is referred to as stable, if the composition is characterized by a sufficient structural and/or mechanical integrity under operable conditions. In some embodiments, the support has a sufficient mechanical and chemical stability (with response to parameters such as moisture, UV/vis radiation) to provide a support for any material (e.g. edible matter) stored within the article. In some embodiments, the term “operable conditions” refers to a temperature below 100° C., or between −40 and 100° C., between −40 and 0° C., between 0 and 50° C., between −40 and 50° C., between 50 and 150° C., between 50 and 100° C., including any range between. In some embodiments, the term “operable conditions” further refers to ambient conditions, e.g. ambient atmosphere, ambient pressure, etc.

In some embodiments, the article is stable (e.g. under operable conditions) for a time period of about 1 month (m), about 10 m, about 20 m, about 2 years (y), about 5 y, about 10 y, or longer including any range between.

In some embodiments, the article is substantially water vapor impermeable. In some embodiments, the article is substantially gas impermeable. In some embodiments, the article is substantially water impermeable.

In some embodiments, the article is substantially water impermeable for a time period of at least 1 h, at least 10 h, at least 20 h, at least 2 days, at least 10 days including any range between.

In one embodiment, the article of the invention is substantially biodegradable and/or recyclable.

In some embodiments, at least 50%, at least 60%, at least 65%, at least 70%, at least 75%, at least 80%, at least 85%, at least 90%, at least 95% w/w of the article is biodegradable. In some embodiments, the plasticizer enhances biodegradability of the composition or article. In some embodiments, the article loses it structural intactness upon contact with a microorganism (e.g. bacteria or fungi) and/or water.

As used herein, the term “substantially” refers to at least 70%, at least 75%, at least 80%, at least 85%, at least 90%, at least 95%, at least 97%, at least 99%.

In a further aspect of the invention, the container or article of the invention may be coated or treated with a bio-degradable coating comprising polylactic acid (PLA), or any biodegradable polymer known in the art. In some embodiments, the coating is a hydrophobic coating.

### Manufacturing Process

In another aspect, there is a process for manufacturing the article of the invention, comprising:
(i) providing the composition of the invention;
(ii) exposing the composition to conditions suitable for molding, thereby obtaining a moldable composition;
(iii) modeling the moldable composition, thereby forming the article.

In some embodiments, the composition is prepared by mixing the component of the composition (such as the cellulose-based polymer and the plasticizer and optionally the additive) under appropriate conditions. In some embodiments, appropriate conditions comprise heating to a temperature between 130 and 300° C. In some embodiments, appropriate conditions comprise heating to a temperature between 130 and 300° C. and exposing the composition to a shear stress sufficient for forming a homogeneous composition. Exemplary conditions are as described in the Examples section.

In some embodiments, step (ii) of the method comprises exposing the composition to conditions suitable for molding, thereby obtaining a moldable composition. In some embodiments, conditions suitable for molding comprise exposing the composition to a temperature about the softening point. In some embodiments, conditions suitable for molding comprise exposing the composition to a temperature about the Tm. In some embodiments, conditions suitable for molding comprise thermal exposure in a range between 100 and 300° C., thereby melting or softening the composition. In some embodiments, conditions suitable for molding comprise providing the composition under conditions suitable for melting or softening the composition.

In some embodiments, step (iii) of the method comprises modeling the moldable composition, thereby forming the article. In some embodiments, step (iii) of the method comprises modeling the composition in a molten state.

In some embodiments, modeling comprises providing a predetermined shape to the moldable composition. In some embodiments, modeling comprises forming or shaping the composition or the moldable composition in a molten state. In some embodiments, modeling comprises exposing the moldable composition to a compression force suitable for deforming the moldable composition. In some embodiments, steps (ii) and (iii) are performed simultaneously or subsequently.

In some embodiments, the compression force is suitable for providing the moldable composition into a predetermined shape. In some embodiments, the predetermined shape is predetermined by a shape of a mold. In some embodiments, the compression force is suitable for transferring the molten composition into a mold.

In some embodiments, the compression force is suitable for extruding the moldable composition.

In some embodiments, modeling is by a process selected from the group consisting of: extrusion, molding, spinning, compression, injection, non-woven, blowing and thermoforming or any combination thereof.

In some embodiments, the method comprises modeling or shaping the mixture, thereby forming the article. In some embodiments, modeling comprises molding the composition thereby forming the article. In some embodiments, molding comprises compression molding. In some embodiments, a process for manufacturing the article of the invention is as described hereinbelow (Example 1).

The following Examples are representative of techniques employed by the inventors in carrying out aspects of the present invention. It should be appreciated that while these techniques are exemplary of embodiments for the practice of the invention, those of skill in the art, in light of the present disclosure, will recognize that numerous modifications can be made without departing from the intended scope of the invention.

### EXAMPLES

### Example 1

### Preparation of EC-Based Compositions

EC 45 (ethylcellulose) powder was grounded for one minute in a lab scale grinder and followed by plasticizer addition at different wt %, and additional 5 min grinding. The EC/plasticizer mixture was introduced in small portions to the roller measuring head of a Brabender Plasticorder (DUISBURG D-4100, Germany). The temperature during processing was kept at 170° C. and a mixing rate of 25 rpm was used. After approximately 15 min of processing, the polymer was taken out and cut manually to smaller pieces to allow easy handling later.

### Preparation of an Exemplary EC-Based Film:

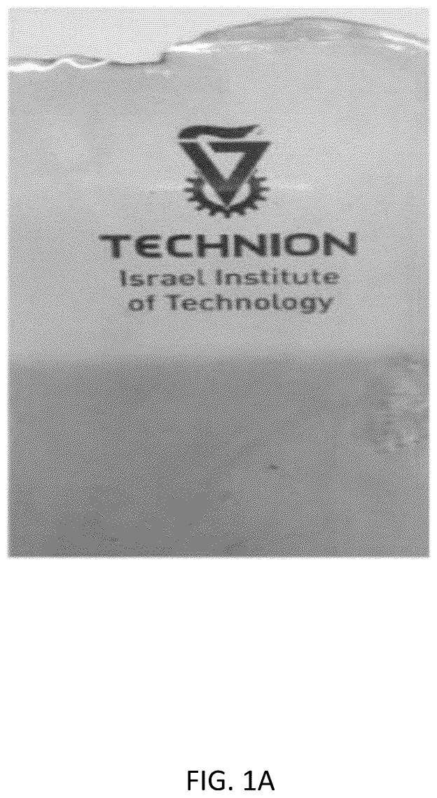

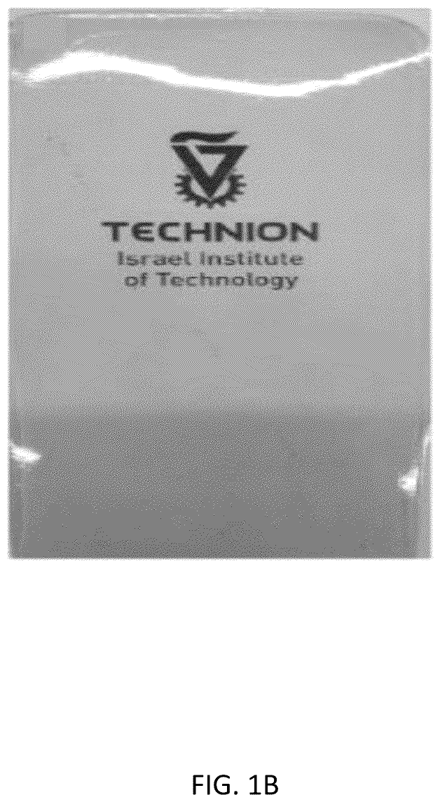

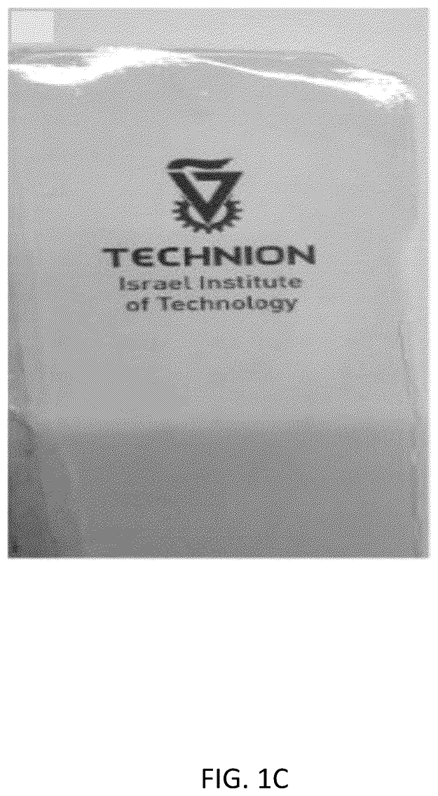

Films were prepared using a mini-industrial hydraulic press. The films were created using two rectangle shape molds 15 cm. by 7 cm. in size able to produce a 300 μm and a 50 μm thick films using 3.6 gr. and 0.6 gr polymer, respectively. Press was operated using with 200° C. for 20 minutes followed by compression using a 10 N force for 10 minutes then the molds were taken out of the press and were left to cool until they reached room temperature were the films were extracted. The resulting films (as represented by FIG. 1) exhibited high transparency and so can be used for agriculture and food packaging.

### Example 2

### Tensile Properties

The analysis was performed using a TA1 texture Analyzer (AMETEK LLOYD, United Kingdom) equipped with 500N load cell and a constant extension rate of 10 mmmin-1. The resulting information was analyzed by NEXYGENPlus software and relay on the ASTM method. The films were cut into a rectangular shape having an average dimension of 9 mm width, 20 mm length and 0.15 mm thickness, which measured by a digital caliber.

The stress was calculated automatically by dividing the tension force (F) in the cross-sectional area (A) (Eq. 1) which was calculated using Eq. 2

$$Stress [ Mpa ] = \frac{F [ N ]}{A [ {mm}^{2} ]} \qquad Eq . 1$$

$$A [ {mm}^{2} ] = a [ mm ] * b [ mm ] \qquad Eq . 2$$

The tension strain is calculated as the ratio between the change in length (ΔL) to the original length (L0) (Eq. 3). The initial slope of the stress-strain curve is considered linear and so can be adequately described by Hooke's law (which expresses the constant relationship between stress (σ) and strain (ε) for an ideal elastic solid) (Eq. 4). This constant (E), known as the elastic modulus of the material, was calculated as the slope of the linear area from 0% to 5% strain.

$$Strain [ \% ] = \frac{Δ L [ mm ]}{{L}_{0} [ mm ]} * 100 \% \qquad Eq . 3$$

$$σ = E * ε \qquad Eq . 4$$

FIG. 2 represents typical stress-strain curves of the different formulations. The curve obtained for the EC film exhibits approximately linear behavior according to which elongation is proportional to the increase in strength, while the breaking point (point A) occurs at low strain and high stress. This behavior is typical for brittle materials under extensional deformation, at a temperature below their T_{g}. The curves obtained for EC/plasticizer samples demonstrate a similar stress-strain relationship according to which under low deformation, all curves exhibit a linear relationship (similar to EC) up to the yield point (point B). This point indicates the transition from elastic to plastic deformation, which is characterized by a decrease and subsequent increase in stress upon elongation, eventually reaching maximum deformation and tearing.

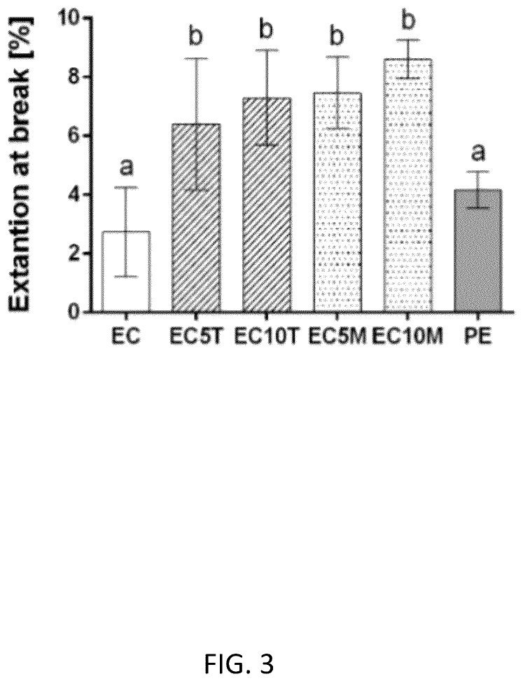

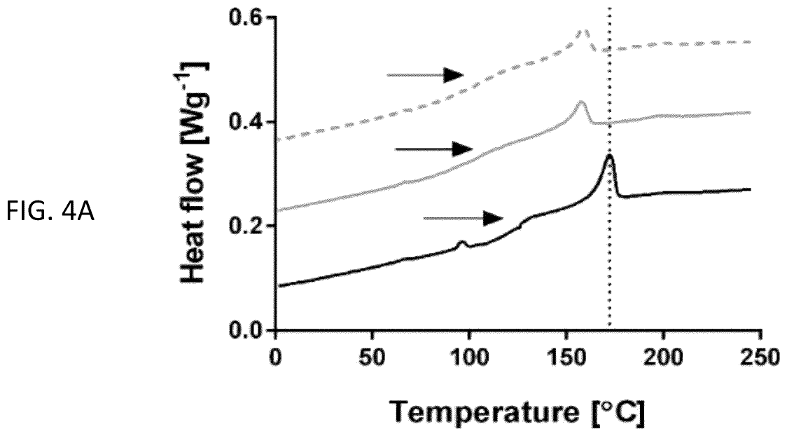

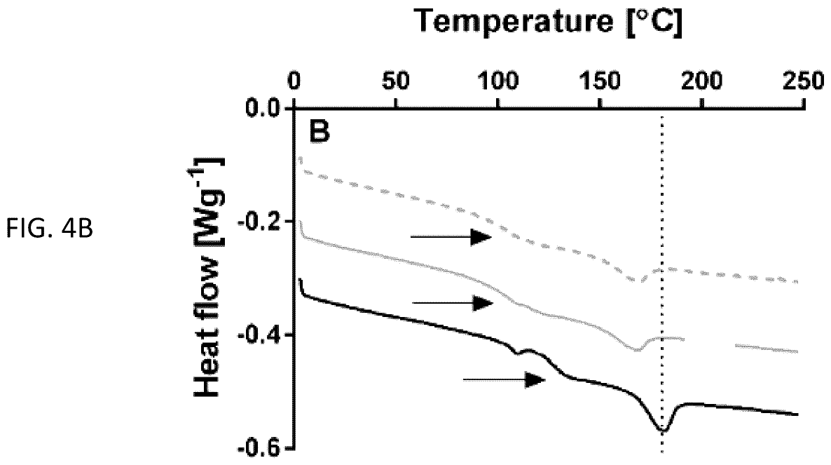

In order to assess the impact of adding plasticizers on the elastic response to applied stress the extension at break point were calculated (FIG. 3).

The addition of plasticizer molecules to EC increased the film's endurance to extension leading to a larger extension at break (FIG. 3). Film elongation increased from 11.42% for pure EC film to 30.97% or 43.69% depending on the plasticizer type and concentration.

### Example 3

### Dynamic Mechanical Analysis (DMA)

The thermal-mechanical properties and the film's viscoelastic behavior were carried out by dynamic mechanical analysis (DMA). A rectangular-shaped sample was fixed and the deformation caused by applying a sinusoidal oscillatory force was analyzed. While an ideal elastic material will respond immediately with the applying force, an ideal viscous one will respond with a phase lag equals to 90°. As for a viscoelastic material the phase angle between depending on how much viscous behavior the sample has as well as how much elastic behavior. The measurement is carried out over a defined temperature range so that at each point the lag between the stress and strain sine waves and the amplitude of the strain at the maximum of the sine wave are measured. From those parameters, features like modulus and glass temperature can be calculated.

The single modulus was resolved into two parts: the storage modulus (E′) and the loss modulus (E″). The storage modulus (also called the elastic modulus) described as the in-phase with the applied stress and correlated to the recoverable elastic energy stored in the material. On the other hand, the loss modulus described as the out-phase and correlated to the ability to lose energy as heat. The tangent of the phase angle (tan δ) defines as the ratio of the loss to the storage modulus. This value is an indicator of the material that tends to lose energy thus for molecular rearrangements and internal friction.

$$tan ( δ ) = \frac{{E}^{″}}{{E}^{′}} = \frac{Loss modulus}{Storage modulus} \qquad Eq . 5$$

This equation applies for response of material changes with temperature at fixed frequency. Thus the profiles of elastic component of the tensile modulus (E′) and the mechanical loss (tan δ) with respect to temperature were obtained. The glass transition of the composite films, Tg, represented by a sharp drop in modulus and a peak for tan δ, can therefore be determined by DMA. The maximum of tan δ and/or a sharp drop in modulus was taken as the glass transition temperature. The upper temperature was limited due to the rapidly decreasing mechanical stability of the plasticized samples above their glass transition temperature. All experiments were performed under a dry nitrogen atmosphere.

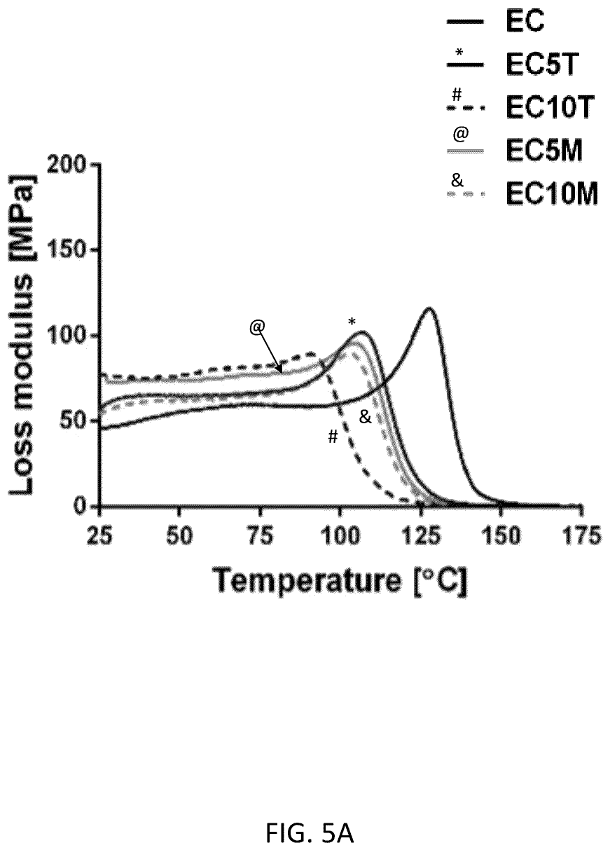

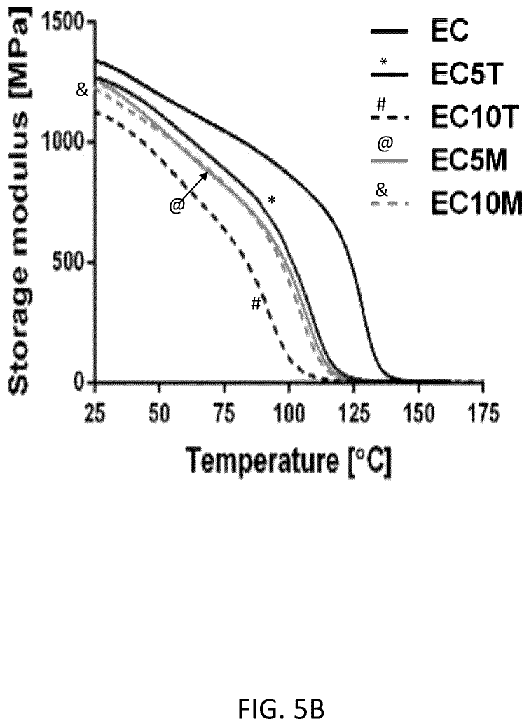

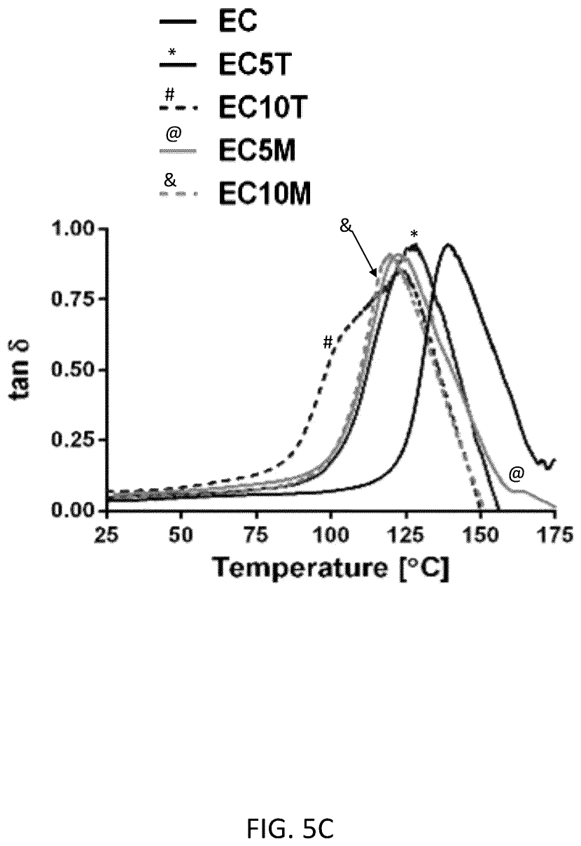

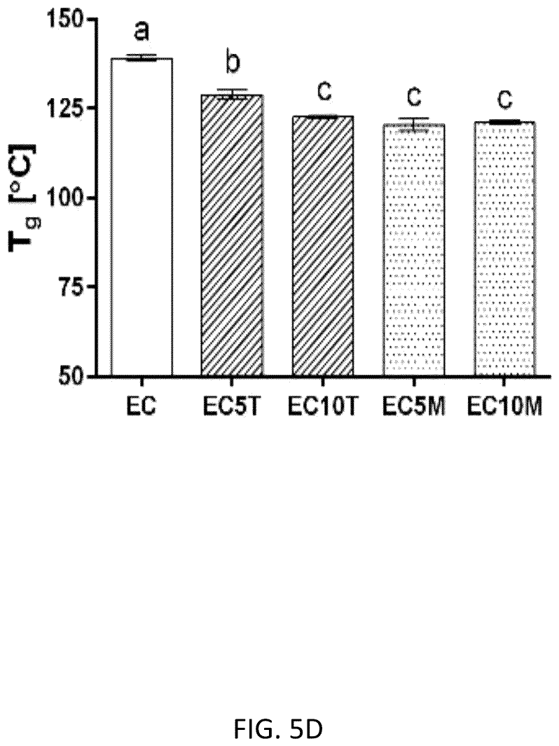

The tan δ value, presented in FIG. 5C, provides important information on the material's viscoelastic properties, in general, and the material glass transition, in specific. As expected, the results show a significant decrease in T_{g} values with the addition of plasticizer. Moreover, EC films exhibited higher storage modulus compared to the EC/plasticizer films, suggesting a higher elastic characteristic, as the storage modulus represents the elastic characteristic while the loss modulus represents the viscous characteristic of a viscoelastic material (FIG. 5B).

A temperature sweep measurement with a tension mode was chosen to detect the response of material changes at fixed frequency. The rectangular shape specimens with dimensions of approximately 15 mm×5 mm and thickness of 0.18 mm were fixed using a single-cantilever configuration clamp. The temperature rises at a rate of 2° C. min-1 from room temperature up to 180° C. as the frequency was kept on 1 Hz. Furthermore, a 0.05% strain was defined as appropriate value in order to stay in the laniary range during the test. Furthermore, a minimum force was determined as a 0.005 N so that when this minimum force was reached, the force was kept constant and the strain was increased. This determination allowed the measurement to be performed under the specified conditions and did not impair the results obtained.

The inventors observed, that EC extrudates (i.e., without the addition of a plasticizer) are substantially devoid of viscoelastic properties (or unshapeable) and upon extrusion result in fragile films. The EC-based extrudates (i.e., without the addition of a plasticizer) are characterized by inferior mechanical stability, and by inferior viscoelastic properties as compared to the extruded compositions of the invention. Accordingly, as opposed to the compositions disclosed herein, EC extrudates are unshapeable, so that it is impossible to fabricate stable articles (optionally with a predefined 3D structure) therefrom.

### Example 4

### Melt Flow Index (MFI)

MFIs of various compositions comprising ethyl cellulose (EC) polymers of different molecular weights and plasticizers (TEC and Myv) have been measured according to a standard protocol. High MFI value indicates on higher flowability of the sample which can be related to lower melt viscosity. Usually, higher MF values are expected for lower molecular weight polymers. This trend can be observed while comparing the pristine EC polymers of different viscosity grades. These polymers exhibit MFI values in the order of EC 10 cP>EC 20 cP>EC 45 cP, which corresponds to the mean molecular weight of the EC being in the order of EC 10 cP<EC 20 cP<EC 45 cP. Moreover, the addition of 5% w/w of the plasticizer (TEC or Myv), led to an increase in the MFI value which can be related to low viscosity expected by the addition of plasticizer (as represented in Table 1 hereinbelow). According to the results represent hereinbelow, there is a strong correlation between the plasticizer type and the measured flowability increase of the composition. As demonstrated by Table 1, TEC increased the EC flowability to a higher extent, compared to Myv in all EC viscosity grades, as demonstrated by a higher MFI % change.

TABLE 1
MFI values of exemplary compositions of the invention,
as compared to pristine EC (control)

| Composition | MFI value | % change |
|---|---|---|
| EC 10cP | 46.76 | — |
| EC 10cP +5% wt. TEC | 56.51 | 20.8 |
| EC 10cP +5% wt. MYV | 48.00 | 2.6 |
| EC 20cP | 21.32 | — |
| EC 20cP +5% wt. TEC | 45.09 | 111.5 |
| EC 20cP +5% wt. MYV | 37.64 | 76.5 |
| EC 45cP | 10.76 | — |
| EC 45cP +5% wt. TEC | 17.74 | 64.9 |
| EC 45cP +5% wt. MYV | 16.48 | 53.2 |

### Example 5

### Effect of Plasticizer on the Glass Transition Temperature

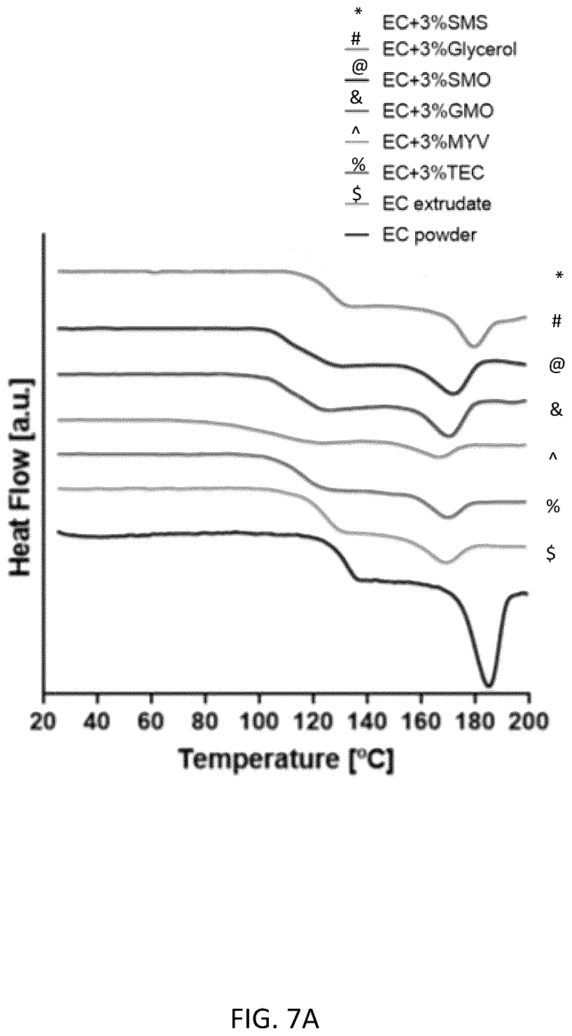

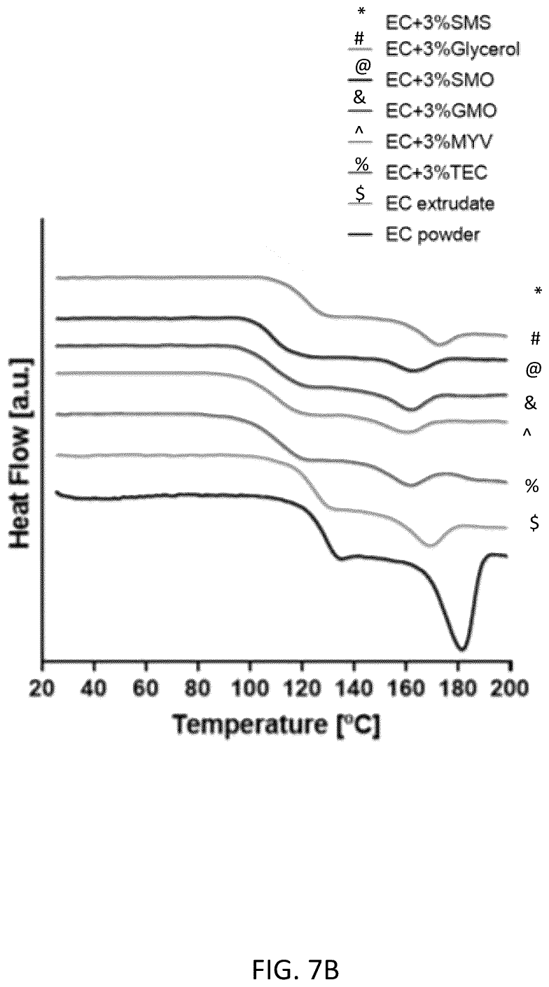

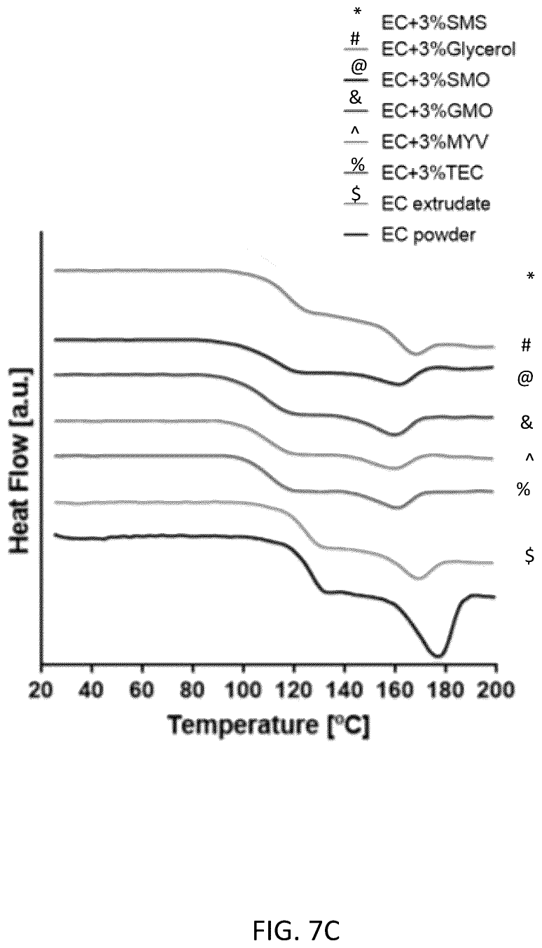

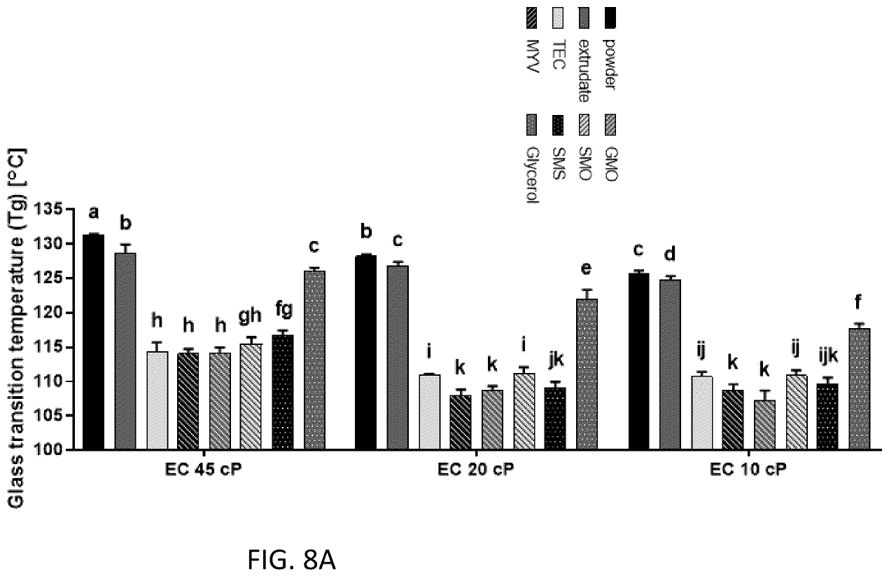

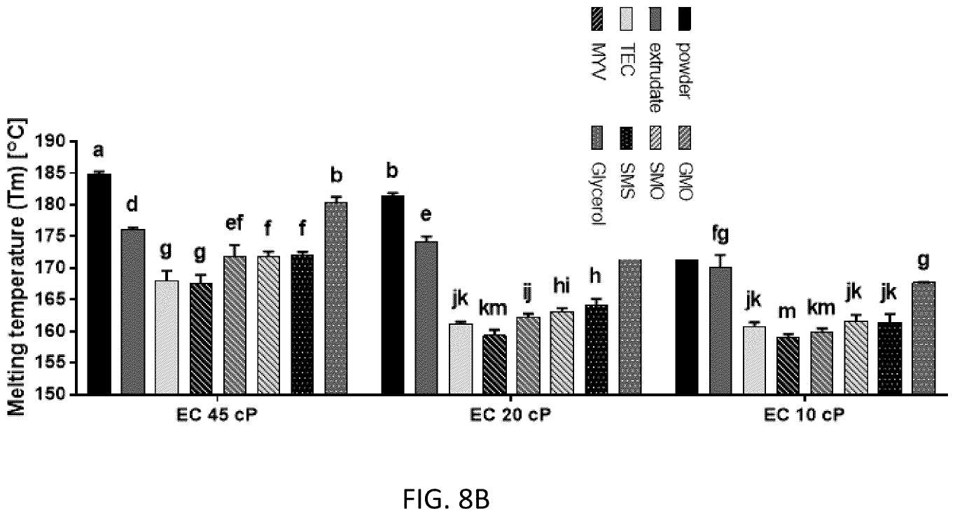

Various EC grades, i.e. molecular weight, and plasticizers were extrudered using a lab scale extruder where the extrudate product was analyzed. The effect of plasticizer addition on the glass transition of different EC grades determined by Differential scanning calorimetry (DSC). FIGS. 7A-C represent the thermogram curves while FIGS. 8A-B and Table 2 summarize the reduction in glass transition and melting temperatures due to plasticizer addition.

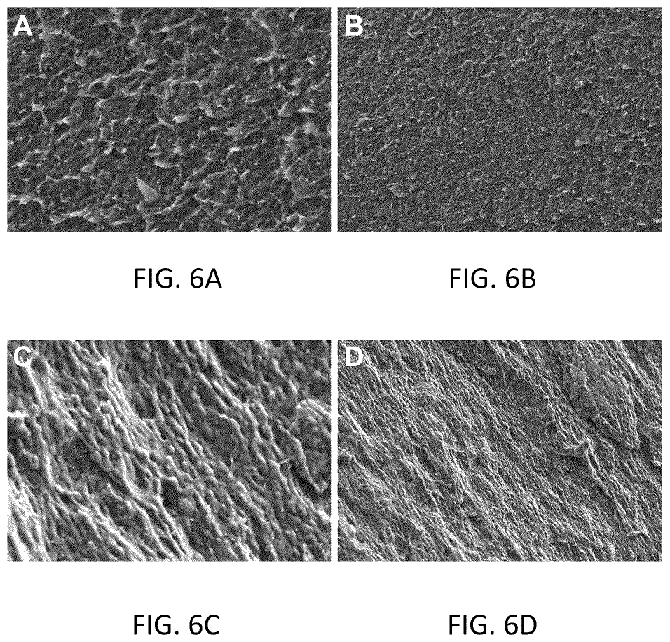

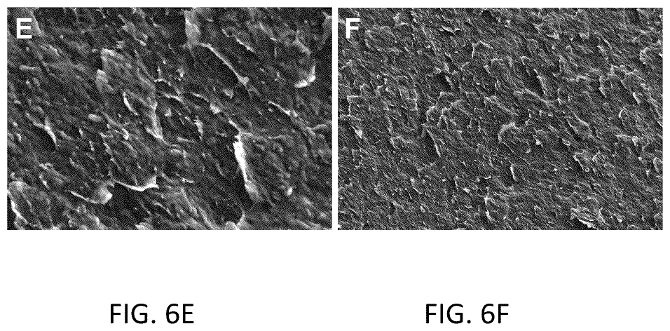

TABLE 2
Transition temperatures (Tg and Tm) calculated from
the DSC thermograms of FIG. 6.

| | | Tg [° C.] | Tm [° C.] |
|---|---|---|---|
| EC 10 cP | EC10 powder | 125.78 ± 0.31^{c} | 176.63 ± 0.02^{c} |
| | EC10 extrudate | 124.73 ± 0.61^{d} | 170.00 ± 2.05^{fg} |
| | EC10 + 3% TEC | 110.70 ± 0.68^{hi} | 160.76 ± 0.67^{jk} |
| | EC10 + 3% MYV | 108.67 ± 0.93ⁱ | 159.08 ± 0.49^{m} |
| | EC10 + 3% GMO | 107.32 ± 1.35ⁱ | 159.77 ± 0.69^{km} |
| | EC10 + 3% SMO | 110.90 ± 0.75^{hi} | 161.56 ± 1.07^{jk} |
| | EC10 + 3% SMS | 109.69 ± 0.90^{hi} | 161.43 ± 1.28^{jk} |
| | EC10 + 3% Glycerol | 117.73 ± 0.65^{f} | 167.71 ± 0.05^{g} |
| EC 20 cP | EC20 powder | 128.21 ± 0.28^{b} | 181.44 ± 0.42^{b} |
| | EC20 extrudate | 126.88 ± 0.48^{c} | 174.08 ± 0.92^{e} |
| | EC20 + 3% TEC | 110.96 ± 0.13^{h} | 161.26 ± 0.25^{jk} |
| | EC20 + 3% MYV | 108.02 ± 0.84ⁱ | 159.46 ± 0.84^{km} |
| | EC20 + 3% GMO | 108.71 ± 0.61ⁱ | 162.17 ± 0.65^{ij} |
| | EC20 + 3% SMO | 111.12 ± 0.95^{h} | 163.10 ± 0.58^{hi} |
| | EC20 + 3% SMS | 109.09 ± 0.86ⁱ | 164.05 ± 1.11^{h} |
| | EC20 + 3% Glycerol | 122.01 ± 1.32^{e} | 173.12 ± 0.22^{e} |
| EC 45 cP | EC45 powder | 131.31 ± 0.15^{a} | 184.84 ± 0.42ª |
| | EC45 extrudate | 128.73 ± 1.17^{b} | 176.20 ± 0.23^{d} |
| | EC45 + 3% TEC | 114.21 ± 1.41^{g} | 168.02 ± 1.52^{g} |
| | EC45 + 3% MYV | 114.06 ± 0.65^{g} | 167.57 ± 1.35^{g} |
| | EC45 + 3% GMO | 114.20 ± 0.74^{g} | 171.90 ± 1.76^{ef} |
| | EC45 + 3% SMO | 115.40 ± 1.05^{g} | 171.77 ± 0.88^{f} |
| | EC45 + 3% SMS | 116.74 ± 0.69^{f} | 171.99 ± 0.58^{f} |
| | EC45 + 3% Glycerol | 126.05 ± 0.49^{c} | 180.24 ± 1.01^{b} |

Legend: same as in FIG. 8.

### Example 6

### Effect of Plasticizer on the Mechanical Properties

The extrudates were compressed using pressure press and films were prepared. The film's mechanical properties were evaluated using tensile instrument at tensile test rate of 1 mm/min. Higher tensile strength and elongation at break (especially for EC45) were observed while adding different plasticizers, while no significant trend was observed while analyzing the sample Young's modulus. As represented by FIGS. 7 and 8, the plasticizer addition significantly reduces the Tg and/or Tm of the cellulose-based polymer (e.g. EC) and further changes the material mechanical properties, as summarized in Table 3 below.

TABLE 3
Mechanical properties of exemplary extrudates of
the invention, compared to EC extrudate (control)

| | Young's | | Elongation | |
|---|---|---|---|---|
| | modulus (E) | Tensile strength | at Break | Elongation at Yield |
| | [MPa] | [MPa] | [%] | [%] |
| EC10 extrudate | 429.77 ± 41.58 | 14.126 ± 3.137 | 4.24 ± 0.90 | — |
| EC10 + 3% TEC | 487.95 ± 141.22 | 14.530 ± 2.013 | 2.18 ± 4.88 | — |
| EC10 + 3% MYV | 483.04 ± 87.10 | 17.668 ± 1.988 | 5.37 ± 1.48 | — |
| EC10 + 3% GMO | 454.20 ± 102.66 | 12.935 ± 3.183 | 4.20 ± 1.90 | — |
| EC10 + 3% SMO | 588.08 ± 78.82 | 13.892 ± 4.561 | 2.89 ± 0.91 | — |
| EC10 + 3% SMS | 588.85 ± 100.23 | 16.200 ± 4.462 | 3.39 ± 1.19 | — |
| EC10 + 3% Glycerol | 434.91 ± 85.61 | 19.171 ± 4.335 | 6.18 ± 1.35 | — |
| EC20 extrudate | 292.18 ± 50.79 | 18.371 ± 3.016 | 12.16 ± 3.67 | — |
| EC20 + 3% TEC | 455.90 ± 78.08 | 13.317 ± 4.091 | 3.76 ± 1.49 | — |
| EC20 + 3% MYV | 459.42 ± 85.35 | 17.291 ± 6.012 | 5.11 ± 11.62 | — |
| EC20 + 3% GMO | 522.82 ± 84.97 | 19.339 ± 4.992 | 4.83 ± 1.57 | — |
| EC20 + 3% SMO | 408.80 ± 92.49 | 21.640 ± 3.689 | 7.94 ± 2.64 | — |
| EC20 + 3% SMS | 337.22 ± 68.28 | 20.161 ± 2.890 | 9.86 ± 4.00 | — |
| EC20 + 3% Glycerol | 363.52 ± 80.42 | 13.749 ± 3.003 | 5.56 ± 2.36 | — |
| EC45 extrudate | 569.39 ± 126.62 | 20.037 ± 4.868 | 4.87 ± 2.24 | — |
| EC45 + 3% TEC | 635.95 ± 71.92 | 29.046 ± 1.423 | 17.31 ± 4.56 | 8.71 ± 0.85 |
| EC45 + 3% MYV | 562.50 ± 43.82 | 28.232 ± 2.283 | 23.21 ± 6.41 | 9.87 ± 0.98 |
| EC45 + 3% GMO | 661.16 ± 136.01 | 31.054 ± 4.132 | 47.98 ± 18.67 | 7.64 ± 1.44 |
| EC45 + 3% SMO | 661.14 ± 83.84 | 29.927 ± 2.928 | 28.99 ± 16.47 | 6.86 ± 1.02 |
| EC45 + 3% SMS | 540.15 ± 88.82 | 32.007 ± 3.361 | 20.11 ± 1.89 | 10.18 ± 1.39 |
| EC45 + 3% Glycerol | 590.79 ± 104.24 | 29.237 ± 1.991 | 29.57 ± 12.12 | 8.86 ± 2.27 |

The inventors further tested additional properties of the extruded compositions of the invention.

Oxygen transmission rate has been measured by OTR analyzer—Ox-Tran 2/22H (Mocon) at 23° C., 0% RH (50 cm² or masked 5 cm²). The oxygen permeability of the tested samples was higher than 200 cc/(m²*day).

Water vapor transmission rate has been measured by WVTR analyzer—Permatran-W 3/34G (Mocon) at 38° C., 90% RH (50 cm² or masked 5 cm²). The WVTR values of the exemplary compositions have been compared to corresponding values of LDPE and of pristine EC45. As shown in Table 4, the addition of a plasticizer results in modified (increased or decreased) WVTR values of the exemplary extruded compositions.

TABLE 4
WVTR values of the exemplary extruded compositions as
compared to LDPE and pristine EC45 (control)

| | $WVTR [ \frac{g}{{m}^{2} \cdot day} ]$ |
|---|---|
| LDPE | 1.2640 |
| EC45 | 104.6709 |
| EC45 + 3% TEC | 109.1173 |
| EC45 + 3% MYV | 109.7366 |
| EC45 + 3% GMO | 109.5121 |
| EC45 + 3% SMO | 109.7636 |
| EC45 + 3% SMS | 81.4372 |
| EC45 + 3% Glycerol | 107.3455 |

Surface contact angle of the exemplary extruded compositions has been measured, and further compared to LDPE and pristine EC45 (control). The results are summarized in Table 5, below.

TABLE 5
Surface contact angles of the exemplary extruded compositions
as compared to LDPE and pristine EC45 (control)

| | Contact angle [°] |
|---|---|
| LDPE | 75.16 ± 1.79^{c} |
| EC45 | 81.79 ± 1.22^{b} |
| EC45 + 3% TEC | 57.94 ± 1.06^{e} |
| EC45 + 3% MYV | 87.27 ± 2.36ª |
| EC45 + 3% GMO | 63.11 ± 1.21^{d} |
| EC45 + 3% SMO | 73.09 ± 1.67^{c} |
| EC45 + 3% SMS | 60.05 ± 1.43^{e} |
| EC45 + 3% Glycerol | 56.90 ± 1.91^{e} |
| EC20 | 73.11 ± 1.62^{c} |
| EC10 | 72.83 ± 1.07^{c} |

Contact angle measures the interaction between liquid droplet and the film surface. The inventors used water as liquid and analyzed the contact angle of various films. Generally, contact angle below 90° for water suggest film with relatively hydrophilic nature. As shown in Table 5, the contact angle of the tested films depends on the polymer molecular weight and the plasticizer used. The contact angle is higher than LDPE in some of the cases and lower in other depending on the composition.

Moreover, the inventors successfully manufactured stable polymeric films (via extrusion) based on ethyl cellulose (e.g. EC 45 cP) and about 3% of a polymeric plasticizer such as: Halloysite nanotubes (HNT), gelatin protein, Polycaprolactone polymer (2000 Da), starch fibers, alginate, zein protein, and polyethylene glycol (PEG, 20 kDa). It is further presumed, that additional biodegradable/biocompatible polymeric compounds can be successfully utilized as the plasticizer in the composition of the invention.

Disclosed and described, it is to be understood that this invention is not limited to the particular examples, process steps, and materials disclosed herein as such process steps and materials may vary somewhat. It is also to be understood that the terminology used herein is used for the purpose of describing particular embodiments only and not intended to be limiting since the scope of the present invention will be limited only by the appended claims and equivalents thereof.

1. A composition comprising (i) a cellulose-based polymer, and (ii) a plasticizer; wherein a weight per weight (w/w) concentration of said plasticizer within said composition is from 0.1 to 20%; and wherein a glass transition temperature (Tg) of said composition is reduced by at least 20% compared to a Tg of said cellulose-based polymer, wherein said composition is characterized by a glass transition temperature (Tg) of less than 130° C.; and wherein said composition is extrudable.

2. The composition of claim 1, wherein said plasticizer is biodegradable.

3. The composition of claim 1, wherein said cellulose-based polymer comprises at least one of: alkyl cellulose, nitrocellulose, carboxylated cellulose or any combination thereof.

4. The composition of claim 3, wherein said alkyl cellulose comprises ethylcellulose, methylcellulose, propylcellulose, hydroxypropyl cellulose, hydroxyethyl cellulose or any combination thereof.

5. The composition of claim 1, wherein a weight per weight (w/w) concentration of said plasticizer within said composition is between 0.5 and 10%.

6. The composition of claim 1, wherein said plasticizer reduces viscosity of said cellulose-based polymer in a molten state by at least 10%; and wherein said extrudable is a temperature about the melting point of said composition.

7. The composition of claim 1, wherein said plasticizer comprises a food acceptable material.

8. The composition of claim 1, wherein said plasticizer is selected from the group consisting of: a phospholipid, a fatty acid, a monoglyceride, a diglyceride a triglyceride, alkylated citrate, a monosaccharide, a disaccharide, an oligosaccharide, a polysaccharide, a clay mineral nanoparticle, Halloysite nanotubes, an organic polymer, a polyester, a polyethylene glycol, a polycaprolactone, a polyol, starch, starch fiber, a protein, or any combination thereof.

9. The composition of claim 1, wherein said composition is characterized by a melting temperature (Tm) reduced by at least 10% compared to a Tm of said cellulose-based polymer; and is further characterized by at least 10% reduced melt flow index (MFI) as compared to MFI of said cellulose-based polymer.

10. (canceled)

11. (canceled)

12. The composition of claim 1, further comprising between 0.1 and 10% additive by weight of said composition.

13. (canceled)

14. An article shaped from the composition of claim 1 wherein said article is in a form of a film, a non-woven fabric, or in a form of a container.

15. The article of claim 14, characterized by at least 50% enhanced elongation at break as compared to a similar article consisting of said cellulose-based polymer.

16. The article of claim 14, wherein said article is substantially water vapor impermeable.

17. The article of claim 14, wherein said article is characterized by elastic modulus between 300 and 400 MPa.

18. (canceled)

19. A method for manufacturing an article shaped from the composition of claim 1 wherein said article is in a form of a film, a non-woven fabric, or in a form of a container, the method comprises:
(i) providing the composition of claim 1;
(ii) exposing said composition to conditions suitable for molding, thereby obtaining a moldable composition;
(iii) modeling said moldable composition, thereby forming said article; wherein said conditions suitable for molding comprise thermal exposure to a temperature above the Tg of said composition and about the Tm of said composition.

20. (canceled)

21. (canceled)

22. The method of claim 19, wherein said modeling is by a process selected from the group consisting of: extrusion, molding, compression, injection, blowing and thermoforming or any combination thereof.
